(19) United States
(12) Patent Application Publication
(10) Pub. No.: US 2011/0069049 A1
(43) Pub. Date: Mar. 24, 2011

(54) ORGANIC LED CONTROL SURFACE DISPLAY CIRCUITRY

(75) Inventors: VICTOR WONG, AUSTIN, TX (US); JOHN PAULOS, AUSTIN, TX (US)

(73) Assignee: OPEN LABS, INC., AUSTIN, TX (US)

(21) Appl. No.: 12/565,411

(22) Filed: Sep. 23, 2009

(51) Int. Cl. G09G 5/00; G09G 3/30

(52) U.S. Cl. 345/205; 345/76

(57) ABSTRACT

An embodiment of a display apparatus includes a display panel having at least one segment line, at least one common line, and at least one display element coupled between the at least one segment line and the at least one common line. The display apparatus further includes a first segment driver circuit having at least one first segment driver coupled to a first end of the at least one segment line, and a second segment driver circuit having at least one second segment driver coupled to a second end of the at least one segment line. The display apparatus further includes a first common driver circuit having at least one first common driver coupled to a first end of the at least one common line, and a second common driver circuit having at least one second common driver coupled to a second end of the at least one common line.

### TECHNICAL FIELD

Embodiments of the invention are related to matrix displays, and more specifically, to an apparatus for driving an organic light-emitting diode (OLED) display.

### BACKGROUND

Organic light-emitting diode (OLED) displays provide many advantages over traditional matrix displays, such as liquid crystal displays (LCDs), including the capability of providing thinner and more flexible displays, lower power consumption, and a wider viewing angle. An OLED is constructed from a number of thin films which, when applied with a supply current, produce monochromatic or polychromatic light through electroluminescence. An OLED display panel is constructed by arranging a number of OLEDs in a matrix configuration. Due to the use of thin films in their construction, OLED displays provide a thin, lightweight form factor. In addition, the supply current required to produce electroluminescence is very small in comparison to an LCD display. Additionally, OLED displays do not require the use of a backlight as required by LCD displays.

Control consoles, such as audio mixing consoles, typically include display devices used to add labels to identify the function of control devices on the surface of the control console. Typically, an individual display device is required for each label requiring the use of a number of display devices to identify each control device. The use of individual display for each label of the control console is cumbersome and requires extensive wiring to accomplish.

### SUMMARY

An embodiment of a display apparatus includes a display panel having at least one segment line, at least one common line, and at least one display element coupled between the at least one segment line and the at least one common line. The display apparatus further includes a first segment driver circuit including at least one first segment driver coupled to a first end of the at least one segment line. The at least one first segment driver is configured to receive a first control signal and provide a first driving signal to the first end of the at least one segment line in response to receiving the first control signal. The display apparatus further includes a second segment driver circuit including at least one second segment driver coupled to a second end of the at least one segment line. The at least one second segment driver is configured to receive a second control signal and provide a second driving signal to the second end of the at least one segment line in response to receiving the second control signal. The display apparatus further includes a first common driver circuit including at least one first common driver coupled to a first end of the at least one common line. The at least one first common driver is configured to receive a third control signal and couple the at least one display element to a bias potential in response to receiving the third control signal. The display apparatus still further includes a second common driver circuit including at least one second common driver coupled to a second end of the at least one common line. The at least one second common driver is configured to receive the third control signal and couple the at least one display element to the bias potential in response to receiving the third control signal.

An embodiment of a control console includes a display panel having at least one segment line, at least one common line, and at least one display element coupled between the at least one segment line and the at least one common line. The display panel includes one or more cut-outs therethrough. The control console further includes a first segment driver circuit including at least one first segment driver coupled to a first end of the at least one segment line. The at least one first segment driver is configured to receive a first control signal and provide a first driving signal to the first end of the at least one segment line in response to receiving the first control signal. The control console further includes a second segment driver circuit including at least one second segment driver coupled to a second end of the at least one segment line. The second segment driver circuit is configured to receive a second control signal and provide a second driving signal to the second end of the at least one segment line in response to receiving the second control signal. The control console still further includes a first common driver circuit including at least one first common driver coupled to a first end of the at least one common line. The at least one first common driver is configured to receive a third control signal and couple the at least one display element to a bias potential in response to receiving the third control signal. The control console further includes a second common driver circuit including at least one second common driver coupled to a second end of the at least one common line. The at least one second common driver is configured to receive the third control signal and couple the at least one display element to the bias potential in response to receiving the third control signal. The control console still further includes at least one control device passing through the at least one cut-out.

Another embodiment of a display apparatus includes a display panel having at least one segment line, at least one common line, and at least one display element coupled between the at least one segment line and the at least one common line. The display apparatus further includes a first segment driver circuit including at least one first segment driver coupled to a first end of the at least one segment line. The at least one first segment driver is configured to receive a first control signal and provide a first driving signal to the first end of the at least one segment line in response to receiving the first control signal. The display apparatus further includes a second segment driver circuit including at least one second segment driver coupled to a second end of the at least one segment line. The at least one second segment driver is configured to receive a second control signal and provide a second driving signal to the second end of the at least one segment line in response to receiving the second control signal. The display apparatus further includes a first common driver circuit including at least one first common driver coupled to a first end of the at least one common line. The at least one first common driver is configured to receive a third control signal and couple the at least one display element to a bias potential in response to receiving the third control signal.

Another embodiment of a display apparatus includes a display panel having at least one segment line, at least one common line, and at least one display element coupled between the at least one segment line and the at least one common line. The display apparatus further includes a first segment driver circuit including at least one first segment driver coupled to a first end of the at least one segment line. The at least one first segment driver is configured to receive a first control signal and provide a first driving signal to the first end of the at least one segment line in response to receiving the first control signal. The display apparatus further includes a first common driver circuit including at least one first common driver coupled to a first end of the at least one common line. The at least one first common driver is configured to receive a second control signal and couple the at least one display element to a bias potential in response to receiving the second control signal. The display apparatus still further includes a second common driver circuit having at least one second common driver coupled to a second end of the at least one common line. The at least one second common driver is configured to receive the second control signal and couple the at least one display element to the bias potential in response to receiving the second control signal.

An embodiment of a display includes a plurality of illuminating elements arranged in an array of rows and columns, a plurality of row lines for delivering a row signal to connected ones of the illuminating elements in an associated row, and a plurality of column lines for delivering a column signal to connected ones of the illuminating elements in an associated column. The display further includes at least one opening defined in the array. The at least one opening defines one or more discontinuities in the associated row and column lines. The display further includes signal generators for generating column and row signals to either end of the row and signal lines such that the plurality of illuminating elements can be illuminated on either side of the at least one opening.

### BRIEF DESCRIPTION OF THE DRAWINGS

For a more complete understanding, reference is now made to the following description taken in conjunction with the accompanying Drawings in which:

FIG. 1 illustrates an embodiment of a structure of an OLED;

FIG. 2 illustrates an embodiment of an OLED display driving apparatus;

FIG. 3 illustrates an embodiment of a timing diagram for the OLED display driving apparatus of FIG. 2;

FIG. 4 illustrates another embodiment of a timing diagram for the OLED display driving apparatus of FIG. 2;

FIG. 5 illustrates an embodiment of an OLED display driving apparatus having a substantially rectangular cut-out through the OLED display panel;

FIG. 6 illustrates an embodiment of an OLED display driving apparatus having a substantially circular cut-out and substantially rectangular cut-out through the OLED display panel;

FIG. 7 illustrates an embodiment of an OLED display system including the OLED display driving apparatus of FIG. 2;

FIGS. 8A-8C illustrate an embodiment of an audio mixing console including the OLED display driving apparatus of FIG. 2;

FIG. 9 illustrates a perspective view of an embodiment of an audio mixing console having an OLED display panel affixed to a surface of a console top having a curvilinear profile;

FIG. 10 illustrates an embodiment of an LCD display driving apparatus; and

FIG. 11 illustrates an embodiment of an LCD display driving apparatus having a substantially circular cut-out and substantially rectangular cut-out through the LCD display panel.

### DETAILED DESCRIPTION

Referring now to the drawings, wherein like reference numbers are used herein to designate like elements throughout, the various views and embodiments of organic LED control surface display circuitry are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

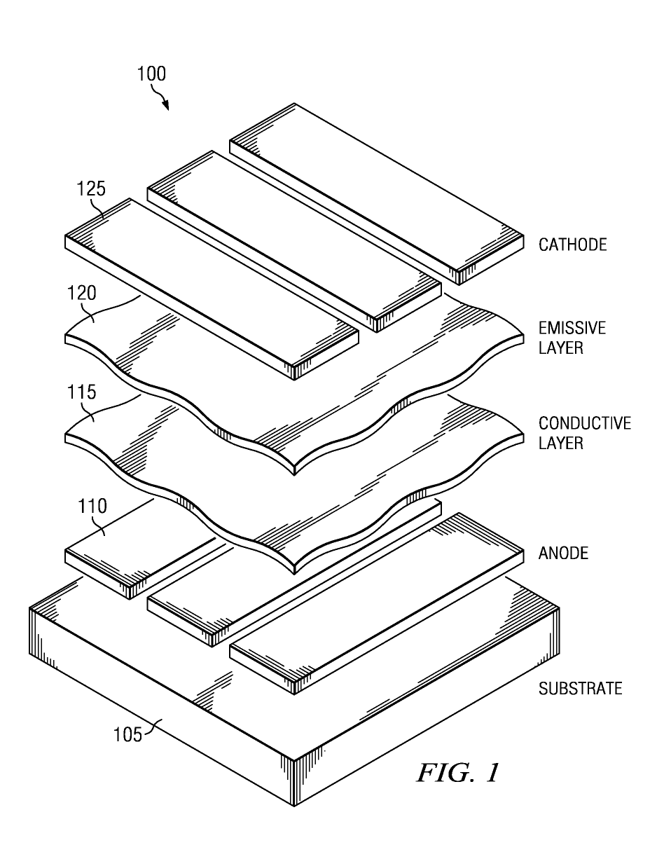

FIG. 1 illustrates an embodiment of a structure of an OLED 100. The OLED 100 is an illuminating element which has a layered structure comprising a substrate 105, an anode 110, a conductive layer 115, an emissive layer 120, and a cathode 125. Typically, the anode 110 is deposited on the substrate 105, the conductive layer 115 overlays the anode 110, the emissive layer 120 overlays the conductive layer 115, and the cathode 125 overlays the emissive layer 125. The substrate 105 is typically formed of glass or transparent plastic, and may be fixed or made of a flexible material. The anode 110 is typically made of indium-tin-oxide (ITO) which is transparent and allows light to pass through to the substrate 105. The conductive layer 115 and the emissive layer 120 are organic layers which can be made of either organic molecules or polymers. The emissive layer 120, which functions as an electron transport layer, is typically made of tris(8-hydroxyquinolinato)aluminium, commonly abbreviated as Alq₃. The conductive layer 115, which functions as a hole transport layer, may be made from a variety of organic and/or polymer materials. One factor used in determining the composition of the conductive layer 115 is the desired color of the light emission. For example, if green is desired it is common to use the combination of Mq³, where M is a Group III metal and q³ is 8-hydroxyquinolate. Blue may be achieved by using Alq₂OPh and red may be achieved with perylene derivatives. The cathode 125 is typically made of some sort of alloy such as Li:Al or Mg:Ag. These particular alloys are chosen because their low work function enables electrons to be easily pumped into the organic layers. When a voltage is applied across the anode 110 and the cathode 125, the conductive layer 115 passes electron “holes” from the anode 110. The emissive layer 120 passes electrons from the cathode 125. When the holes and electrons interact an exciton is emitted and light is created thereby illuminating the OLED 100.

OLED displays may be either monochromatic or full color. Monochromatic displays include a number of OLEDs of a single color. In contrast, color OLED displays may be constructed using a variety of techniques including (1) using individual red, green, and blue OLED subpixels to form a single pixel; (2) using a white OLED with red, green, and blue passband filters to form a single pixel; (3) using a blue OLED with red and green downconvertors as well as a transparent spacer to pass blue light to form a single pixel; (4) using a white OLED with dielectric stacks to perform microcavity filtering to provide red, green, and blue light to form a single pixel; and (5) and using a single color-tunable OLED that has the capability to be tuned to different colors by varying an applied voltage to form a single pixel.

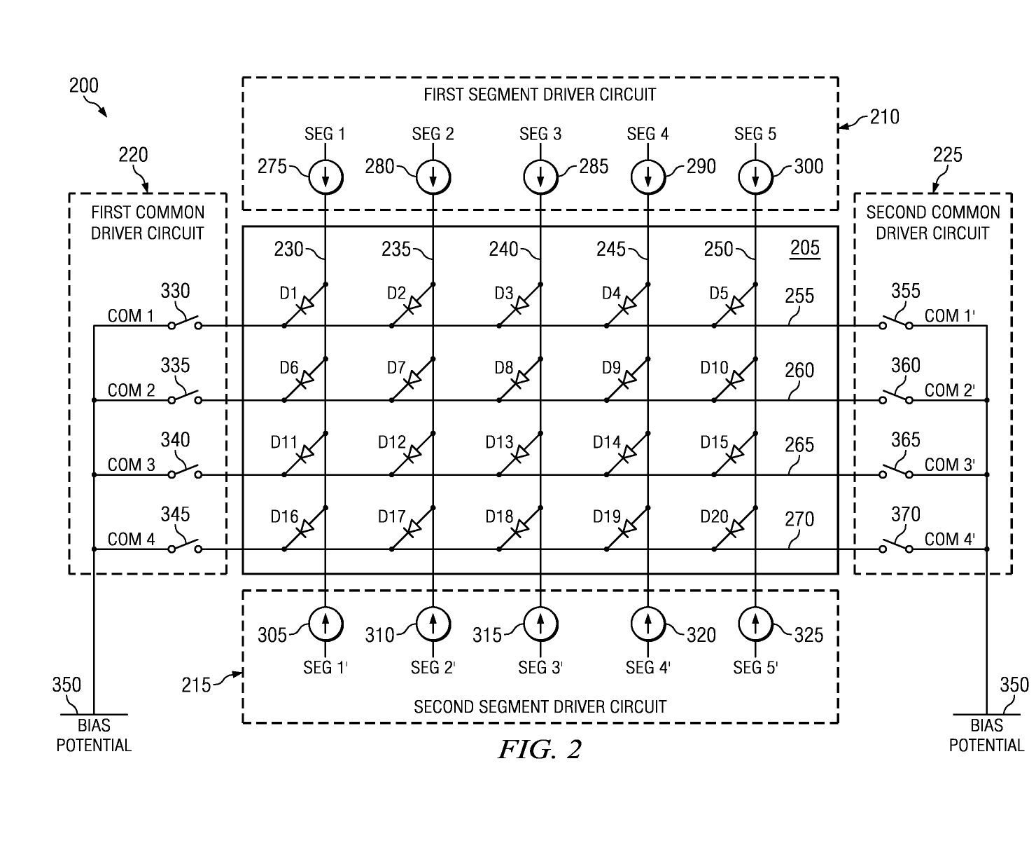

FIG. 2 is an embodiment of an OLED display driving apparatus 200. The OLED display driving apparatus 200 includes an OLED display panel 205, a first segment driver circuit 210, a second segment driver circuit 215, a first common driver circuit 220, and a second common driver circuit 225. The OLED display panel 205 includes a first segment line 230, a second segment line 235, a third segment line 240, a fourth segment line 245, and a fifth segment line 250, each arranged in a substantially vertical orientation and substantially parallel to each other. In at least one embodiment, the first segment line 230, the second segment line 235, the third segment line 240, the fourth segment line 245, and the fifth segment line 250 are column lines of the OLED display panel 205. The OLED display panel further includes a first common line 255, a second common line 260, a third common line 265, and a fourth common line 270, each arranged in a substantially horizontal orientation and substantially parallel to each other. In at least one embodiment, the first common line 255, the second common line 260, the third common line 265, and the fourth common line 270 are row lines of the OLED display panel 205. The segment lines 230-250 and common lines 255-270 are arranged in a grid configuration to form a display matrix. The OLED display panel 205 further includes a number of organic light-emitting diodes (OLEDs) D1-D20. In at least one embodiment the OLED D1-D20 are arranged in an array of rows and columns in the OLED display panel 205. Each of the OLEDs D1-D20 is coupled between a particular segment line 230-250 and particular common line 255-270 as illustrated in FIG. 2. For example, OLED D1 is coupled between the first segment line 230 and the first common line 255, OLED D2 is coupled between the second segment line 235 and the first common line 255, OLED D6 is coupled between the first segment line 230 and the second common line 260, and OLED D20 is coupled between the fifth segment line 250 and the fourth common line 270. Although the described embodiments are illustrated as using twenty OLEDs for the sake of clarity, it should be understood that in other embodiments, an OLED display panel including many more OLEDs may be used. In addition, although the described embodiments are illustrated using a monchromatic OLED display panel 205, it should be understood that color OLED displays may be used in other embodiments.

The first segment driver circuit 210 includes a first segment driver 275 coupled to a first end of the first segment line 230, a second segment driver 280 coupled to a first end of the second segment line 235, a third segment driver 285 coupled to a first end of the third segment line 240, a fourth segment driver 290 coupled to a first end of the fourth segment line 245, and a fifth segment driver 300 coupled to a first end of the fifth segment line 250. The second segment driver circuit 215 includes a sixth segment driver 305 coupled to a second end of the first segment line 230, a seventh segment driver 310 coupled to a second end of the second segment line 235, an eight segment driver 315 coupled to a second end of the third segment line 240, a ninth segment driver 320 coupled to a second end of the fourth segment line 245, and a tenth segment driver 325 coupled to a second end of the fifth segment line 250. In at least one embodiment, each of the first segment driver 275, second segment driver 280, third segment driver 285, fourth segment driver 290, fifth segment driver 300, sixth segment driver 305, seventh segment driver 310, eighth segment driver 315, ninth segment driver 320, and tenth segment driver 325 include a current source. Each of the first segment driver 275, second segment driver 280, third segment driver 285, fourth segment driver 290, fifth segment driver 300, sixth segment driver 305, seventh segment driver 310, eighth segment driver 315, ninth segment driver 320, and tenth segment driver 325 are configured to provide a driving signal to the segment line 230-250 to which it is coupled in response to receiving a respective control signal seg1, seg2, seg3, seg4, seg5, seg1′, seg2′, seg3′ seg4′, and seg5′. In at least one embodiment, the first segment driver circuit 210 and the second segment driver circuit 215 include signal generators for generating one or more column signals to each end of the one or more segment (or column) lines 230-250.

The first common driver circuit 220 includes a first switch 330 coupled to a first end of the first common line 255, a second switch 335 coupled to a first end of the second common line 260, a third switch 340 coupled to a first end of the third common line 265, and a fourth switch 345 coupled to a first end of the fourth common line 270. Each of the first switch 330, second switch 335, third switch 340, and fourth switch 345 are configured to couple the common line 255-270 to which it is coupled to a bias potential 350 in response to receiving a respective control signal com1, com2, com3, and com4. In at least one embodiment, the bias potential 350 is a ground connection. In other embodiments, the bias potential 350 may be a positive bias or a negative bias depending upon requirements of the particular OLED D1-D20. The second common driver circuit 225 includes a fifth switch 355 coupled to a second end of the first common line 255, a sixth switch 360 coupled to a second end of the second common line 260, a seventh switch 365 coupled to a second end of the third common line 265, and an eighth switch 370 coupled to a second end of the fourth common line 270. Each of the fifth switch 355, sixth switch 360, seventh switch 365, and eighth switch 370 are configured to couple the common line 255-270 to which it is coupled to the bias potential 350 in response to receiving a respective control signal com 1′, com2′, com3′, and com4′. In at least one embodiment, the first common driver circuit 220 and the second common driver circuit 225 include signal generators for generating one or more row signals to each end of the one or more common (or row) lines 255-270.

In order to illuminate a particular OLED D1-D20, the segment line 230-250 to which the particular OLED D1-D20 is coupled is provided with one or more driving signals, such as a driving current, and the common line 255-270 to which the particular OLED D1-D20 is coupled is connected to the bias potential 350, thereby coupling the OLED D1-D20 to the bias potential 350 and allowing current to flow through the particular OLED D1-D20 resulting in illumination of the OLED D1-D20. In a particular embodiment in which it is desired to illuminate OLED D1, a first control signal seg1 is provided to the first segment driver circuit 210 indicating that first segment driver circuit 210 should activate first segment driver 275 to provide a first driving signal to a first end of first segment line 230. Additionally, a second control signal seg1′ is provided to the second segment driver circuit 215 indicating that the second segment driver circuit 215 should activate the sixth segment driver 305 to provide a second driving signal to a second end of the first segment line 230. In at least one embodiment, the first driving signal and the second driving signal are applied to the first and second ends of the first segment line 230 at substantially the same time. In other embodiments, the first driving signal and the second driving signal are applied to the first and second ends of the first segment line 230 at different times.

A third control signal (com1) is provided to both the first common driver circuit 220 and a fourth control signal (com1′) is provided to the second common driver circuit 225. The third control signal (com 1) instructs the first common driver circuit 220 to close the first switch 330 to couple a first end of the first common line 255 to the bias potential 350. The fourth control signal (com1′) instructs the second common driver circuit 225 to close the fifth switch 355 to couple a second end of the first common line 255 to the bias potential 350. In various embodiments, the third control signal is the same as the fourth control signal, and the first switch 330 and the fifth switch 355 close at substantially the same time. As a result of the providing of one or more of the first driving signal and the second driving signal to the first segment line 230 by one or more of the first segment driver 275 and the sixth segment driver 305, and the coupling of the first common line 255 to the bias potential 350 by one or more of the first switch 330 or the fifth switch 255, current flows through the OLED D1 resulting in illumination of the OLED D1.

In other embodiments, the first common driver circuit 220 and the second common driver circuit 225 may be configured to provide common driving signals to each of the common lines 255-270 instead of directly coupling the common lines 255-270 to the bias potential 350. In a particular embodiment, the OLED display panel 205 may be an active-matrix display in which each of the OLEDs D1-D20 include a thin film transistor (TFT) (not specifically shown for figure clarity reasons) having a gate that is coupled to a particular common line 255-270. In response to the gate of a TFT associated with a particular OLED D1-D20 receiving the common drive signal from one or more of the first common driver circuit 220 and the second common driver circuit 225, the TFT is switched on thereby coupling the particular OLED D1-D20 to a bias potential 350. The bias potential 350 may be a ground connection, a common ground plane, a positive bias, or a negative bias depending on the type (N or P type) of TFT used in conjunction with the OLED display elements. As a result, the driving signal from one or more of the first segment driver circuit 210 and second segment driver circuit 215 flows through the particular OLED D1-D20 and into the bias potential 350 resulting in illumination of the particular OLED D1-D20. In at least one embodiment, the common driving signals are applied to the first and second ends of the particular common line 255-270 at substantially the same time. In other embodiments, the common driving signals are applied to the first and second ends of the particular common line 255-270 at different times.

In at least one embodiment, an advantage provided by having a first segment driver circuit 210, a second segment driver circuit 215, a first common driver circuit 220, and a second common driver circuit 225, is that one or more of the OLEDs D1-D20 may be cut or otherwise removed from the OLED display panel 205 while still retaining functionality for one or more of the remaining OLEDs coupled to the same segment line and common line as the one or more removed OLEDs D1-D20, as will be further described hereinafter.

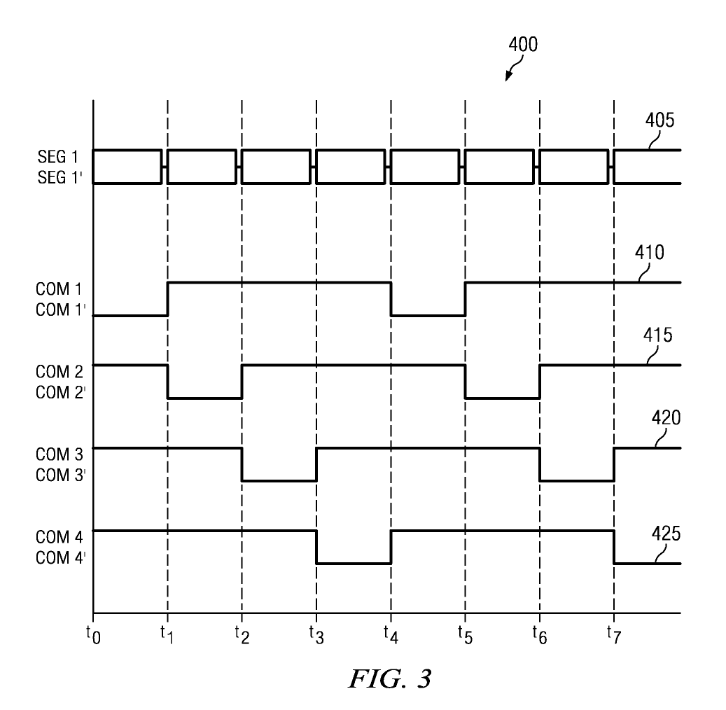

FIG. 3 illustrates an embodiment of a timing diagram 400 for the OLED display driving apparatus 200 of FIG. 2. In the embodiment of FIG. 3, the first segment drive circuit 210 and the second segment driver circuit 215 provide first and second driving signals to the first and second ends, respectively, of a particular segment line 230-250 at substantially the same time. In the embodiment of FIG. 3, the common lines 255-270 are sequentially scanned such that only one of the common lines 255-270 are grounded at a particular time. In addition, the illuminated or non-illuminated state of the OLEDs D1-D20 coupled to the grounded common line 255-270 are set by either turning on or off the associated segment drivers 275-325 during the grounded state of the common line 255-270. For example, in one embodiment the first common line 255 is scanned, then the second common line 260 is scanned, then the third common line 265 is scanned, and finally the fourth common line 270 is scanned. The time required for the sequential scanning of all of the common lines 255-270 is termed a frame period. The process then repeats beginning at the first common line 255 until another frame has been scanned.

Referring again to FIG. 3, the control signals seg1 and seg1′ illustrate embodiments of waveforms 405 for control signals for the first segment driver 275 of the first segment driver circuit 210 and the sixth segment driver 305 of the second segment driver circuit 215, respectively. In the embodiment illustrated in FIG. 3, the control signal seg1 and control signal seg1′ are substantially the same such that the first segment driver 275 and the sixth segment driver 305 are either providing a driving signal or turned off at substantially the same time. The control signals com1 and com1′ illustrate an embodiment of a waveform 410 for control signals for the first switch 330 of the first common driver circuit 220 and the fifth switch 355 of the second common driver circuit 225.

In the illustrated embodiment, the control signals com1 and com1′ are substantially the same such that the first switch 330 and the fifth switch 355 are both either closed or open at substantially the same time. The control signals com2 and com2′ illustrate an embodiment of a waveform 415 for control signals for the second switch 335 of the first common driver circuit 220 and the sixth switch 360 of the second common driver circuit 225. In the illustrated embodiment, the control signals com2 and com2′ are substantially the same such that the second switch 335 and the sixth switch 360 are both either closed or open at substantially the same time. The control signals com3 and com3′ illustrate an embodiment of a waveform 420 for control signals for the third switch 340 of the first common driver circuit 220 and the seventh switch 365 of the second common driver circuit 225. In the illustrated embodiment, the control signals com3 and com3′ are substantially the same such that the third switch 340 and the seventh switch 365 are both either closed or open at substantially the same time. The control signals com4 and com4′ illustrate an embodiment of a waveform 425 for control signals for the fourth switch 345 of the first common driver circuit 220 and the eighth switch 370 of the second common driver circuit 225. In the illustrated embodiment, the control signals com4 and com4′ are substantially the same such that the fourth switch 345 and the eighth switch 370 are both either closed or open during substantially the same time.

At time t₀, the seg1 and seg1′ control signals are set to either high or low depending upon whether OLED D1 is to be illuminated or non-illuminated during a first frame period such that the first segment driver 275 and the sixth segment driver 305 will be either turned on or off. Although not illustrated for clarity purposes, the illuminated or non-illuminated status of OLEDs D2-D5 will also be set by corresponding control signals seg2-seg5 and seg2′-seg5′. The com1 and com1′ control signals are set low indicating that first switch 330 and fifth switch 355 are closed to coupled the first common line 255 to the bias potential 350. The control signals com2, com2′, com3, com3′, and com4, com4′ are set high indicating that switches 335, 340, 345, 360, 365, and 370 are to be open, thus uncoupling common lines 260, 265, and 270 from the bias potential 350. As a result, if OLED D1 is intended to be illuminated during the first frame period, current will flow from the first segment driver 275 and/or sixth segment driver 305 through the OLED D1 and into the bias potential 350. At time t₁, the control signals seg1 and seg1′ control signals are set to either high or low depending upon whether OLED D6 is to be illuminated or non-illuminated during the first frame period and control signals com1 and com1′ are set high resulting in the opening of the first switch 330 and the fifth switch 355. Control signals com2 and com2′ are set low resulting in the closing of the second switch 335 and the sixth switch 360. At time t2, the control signals seg1 and seg1′ control signals are set to either high or low depending upon whether OLED D11 is to be illuminated or non-illuminated during the first frame period and control signals com2 and com2′ are set high resulting in the opening of the second switch 335 and the sixth switch 360. Control signals com3 and com3′ are set low resulting in the closing of the third switch 340 and the seventh switch 365. At time t₃, the control signals seg1 and seg1′ control signals are set to either high or low depending upon whether OLED D16 is to be illuminated or non-illuminated during the first frame period and control signals com3 and com3′ are set high resulting in the opening of the third switch 340 and the seventh switch 365. Control signals com4 and com4′ are set low resulting in the closing of the fourth switch 345 and the eighth switch 370.

At time t₄, the first frame period is completed, all of the common lines 255-270 having been scanned, and a second frame period begins. Beginning at time t₄, the control signals seg1 and seg1′ are set to either high or low depending upon whether OLED D1 is to be illuminated or non-illuminated during the second frame period and control signals com4 and com4′ are set high resulting in the opening of the fourth switch 345 and the eight switch 370. Control signals com1 and com1′ are again set low resulting in the closing of the first switch 330 and the fifth switch 355 to scan the first common line 255. At times t₅, t₆, and t₇, the second common line 260, third common line 265, and fourth common line 270, respectively, are scanned to complete the second frame period.

Accordingly, the first segment driver circuit 210 and the second segment driver circuit 215 provide driving signals at opposite ends of a segment line 230-250 substantially simultaneously. In addition, the first common driver circuit 220 and the second common driver circuit 225 couple each end of a common line 255-270 to the bias potential 350 substantially simultaneously. As a result, the OLED display panel 205 may be cut, resulting in some of the OLEDs D1-D20 being removed and/or portions of one or more segment lines 230-250 and/or common lines 255-270 being broken, while still providing a particular OLED D1-D20 with a driving signal and a bias potential 350 as long as the particular OLED D1-D20 still maintains a connection to at least one end of a common line 255-270 and at least one end of a segment line 230-250.

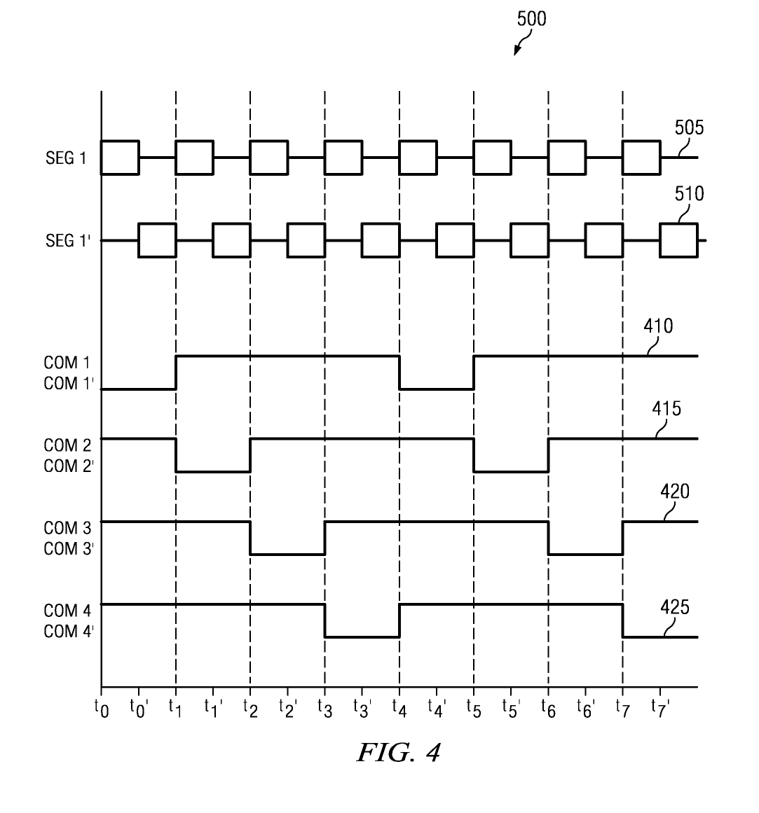

FIG. 4 illustrates another embodiment of a timing diagram 500 for the OLED display driving apparatus 200 of FIG. 2. In the embodiment of FIG. 4, the first segment driver circuit 210 and the second segment driver circuit 215 provide first and second driving signals to the first and second ends, respectively, of a particular segment line 230-250 at substantially alternate times during the scanning of a particular common line 255-270. The embodiment of FIG. 4 may be used in situations in which it is desired to prevent the first segment driver circuit 210 and the second segment driver circuit 215 from providing driving signals to a particular segment line 230-250 at the same time, such as to limit the amount of current that may be applied to a particular OLED D1-D20. In the embodiment of FIG. 4, the common lines 255-270 are sequentially scanned in the same manner as described with respect to FIG. 3 such that only one of the common lines 255-270 are coupled to the bias potential 350 at a particular time. In the embodiment illustrated in FIG. 4, the waveforms for control signals com1, com1′, com2, com2′, com3, com3′, com4, and com4′ are substantially the same as described with respect to FIG. 3. However, in the embodiment illustrated in FIG. 4, the waveform 505 for control signal seg1 and the waveform 510 for control seg1′ are configured such that there is substantially no overlap between the first driving signal being provided by the first segment driver 275 and the second driving signal being provided by the sixth segment driver 305 during a scan period for a particular common line 255-270.

At time t₀, the seg1 control signal is set to either high or low depending upon whether OLED D1 is to be illuminated or non-illuminated during a first frame period such that the first segment driver 275 will be either turned on or off during the scanning of the first common line 255. At time t₀′, the seg1 control signal turns off the first segment driver 275 and the seg1′ control signal is set to either high or low depending upon whether OLED D1 is to be illuminated or non-illuminated during the first frame period. In at least one embodiment, the time t₀′ falls substantially halfway between time t₀ and time t₁ such that the first segment driver 275 and the sixth segment driver 305 provide driving signals to the first segment line 230 for substantially the same length of time during the scanning of the first common line 255, but during substantially alternate time periods. At time t₁, the sixth segment driver 305 turns off and the first segment driver 275 will be either turned on or off during the scanning of the first common line 255 depending upon whether OLED D6 is to be illuminated or non-illuminated during the first frame period. At time t1′, the seg1 control signal turns off the first segment driver 275 and the seg1′ control signal is set to either high or low depending upon whether OLED D6 is to be illuminated or non-illuminated during the first frame period. The process continues for times t₂-t₇′ as illustrated in FIG. 4.

Accordingly, the first segment driver circuit 210 and the second segment driver circuit 215 provide driving signals at opposite ends of a segment line 230-250 at alternate times during the scanning of a particular common line 255-270. As a result, the OLED display panel 205 may be cut, resulting in some of the OLEDs D1-D20 being removed and/or portions of one or more segment lines 230-250 and/or common lines 255-270 being broken, while still providing a particular OLED D1-D20 with a driving signal during at least a portion of the scanning period of a common line 255-270, as well as a grounding connection 350 during substantially the entire portion of the scanning period, as long as the particular OLED D1-D20 still maintains a connection to at least one end of a common line 255-270 and at least one end of a segment line 230-250.

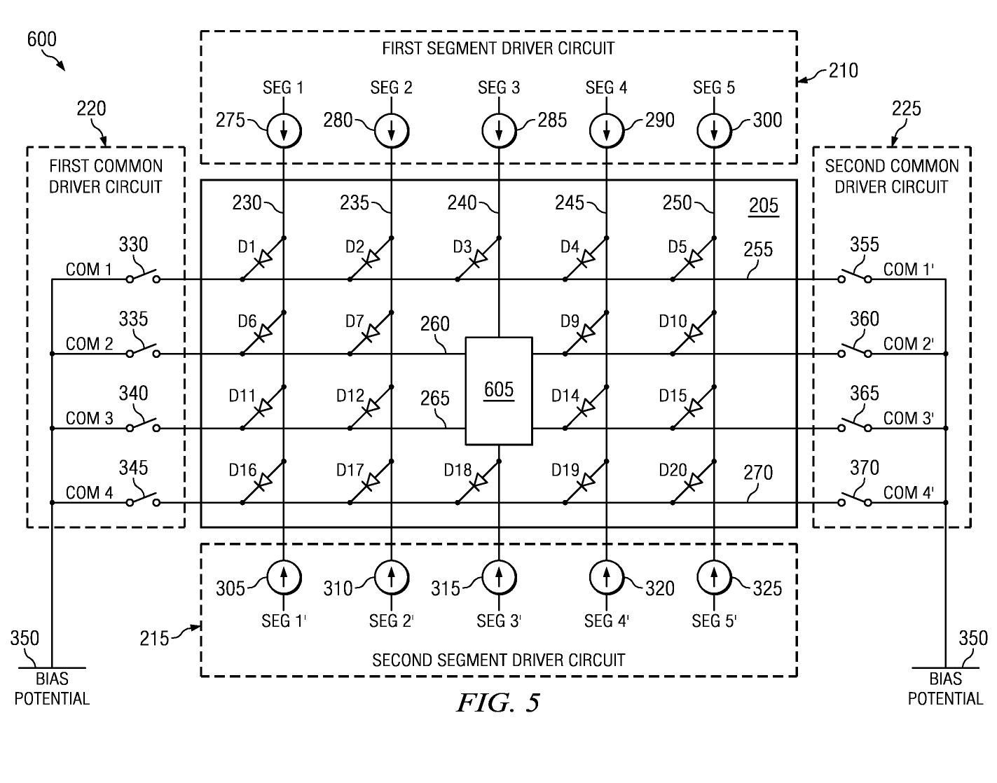

FIG. 5 is an embodiment of an OLED display driving apparatus 600 having a substantially rectangular cut-out 605 defining an opening through the OLED display panel 205. In particular embodiments, the rectangular cut-out 605 may be used to pass one or more control devices, such as a switch or slider, through the OLED display panel 205 as further described herein. In the embodiment illustrated in FIG. 5, the rectangular cut-out 605 results in the removal of OLED D8 and OLED D13, as well as breaks, or discontinuities, in the third segment line 240, the second common line 260, and the third common line 265. The use of the second segment driver circuit 215 to provide a second driving signal to the third segment line 240 and the second common driver circuit 225 to couple common lines 260 and 265 to the bias potential 350, enables the remaining OLEDs D1-D7, D9-D12, and D14-D20 to remain operable despite the presence of the rectangular cut-out 605. Without the use of the second segment driver circuit 215 and second common driver circuit 225, OLEDs D9-D10, D14-D15, and D18 would remain inoperable. Although the embodiment of FIG. 5 is illustrated with respect to a rectangular cut-out 605, it should be understood that in other embodiments the OLED display panel 205 may have one or more cut-outs of any shape and/or size.

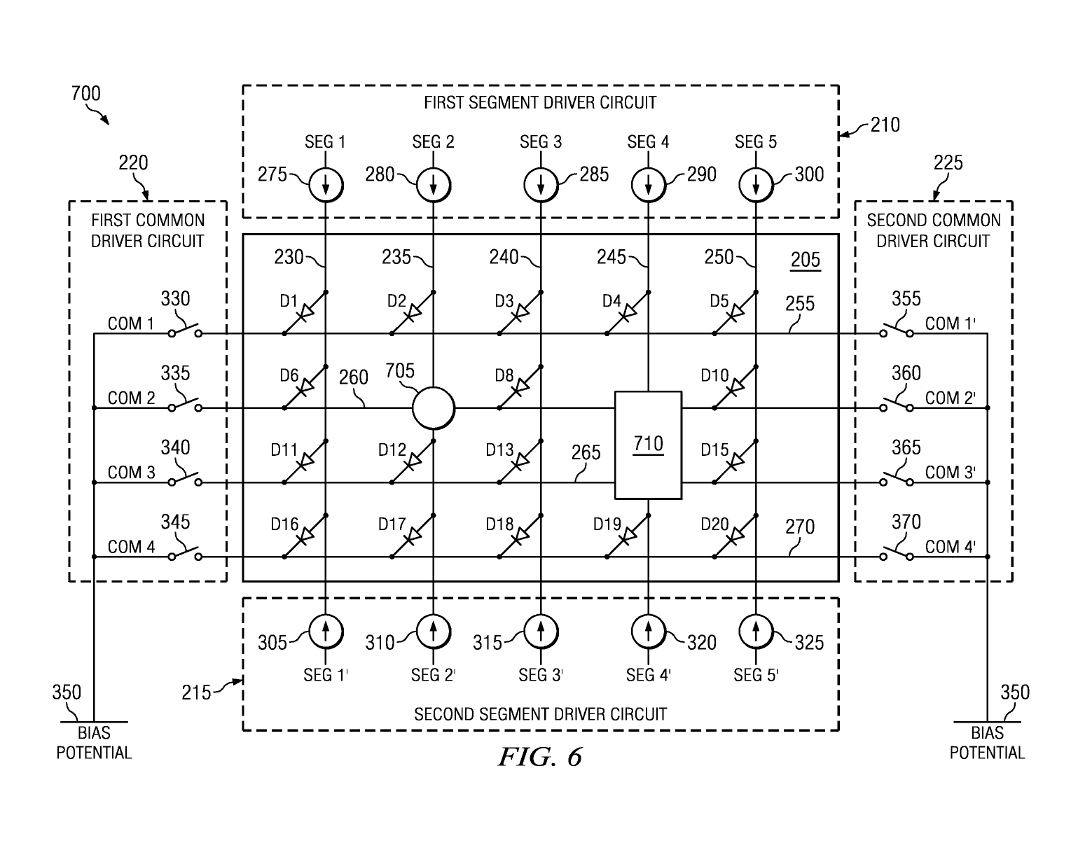

FIG. 6 is an embodiment of an OLED display driving apparatus 700 having a substantially circular cut-out 705 defining a first opening and substantially rectangular cut-out 710 defining a second opening through the OLED display panel 205. In particular embodiments, the circular cut-out 705 and rectangular cut-out 710 may be used to pass one or more control devices, such as switches, sliders, or knobs, through the OLED display panel 205 as further described herein. In the embodiment illustrated in FIG. 6, the circular cut-out 705 results in the removal of OLED D7, as well as breaks, or discontinuities, in the second segment line 235 and the second common line 260. The rectangular cut-out 710 results in the removal of OLED D9 and OLED D14, as well as breaks, or discontinuities, in the fourth segment line 245, the second common line 260, and the third common line 265. Use of the second segment driver circuit 215 to provide a second driving signal to the fourth segment line 245 and the second common driver circuit 225 to couple common lines 260 and 265 to the bias potential 350, enables OLEDs D1-D6, D10-D13, and D15-D20 to remain operable despite the presence of the circular cut-out 705 and the rectangular cut-out 710. However, in the embodiment of FIG. 6, OLED D8 remains inoperative since it has no connection to the bias potential 350. Without the use of the second segment driver circuit 215 and second common driver circuit 225, OLEDs D10, D12, D15, D17, and D19 would also remain inoperable. Although the embodiment of FIG. 6 is illustrated with respect to a circular cut-out 705 and rectangular cut-out 710, it should be understood that in other embodiments the OLED display panel 205 may have one or more cut-outs of any shape and/or size.

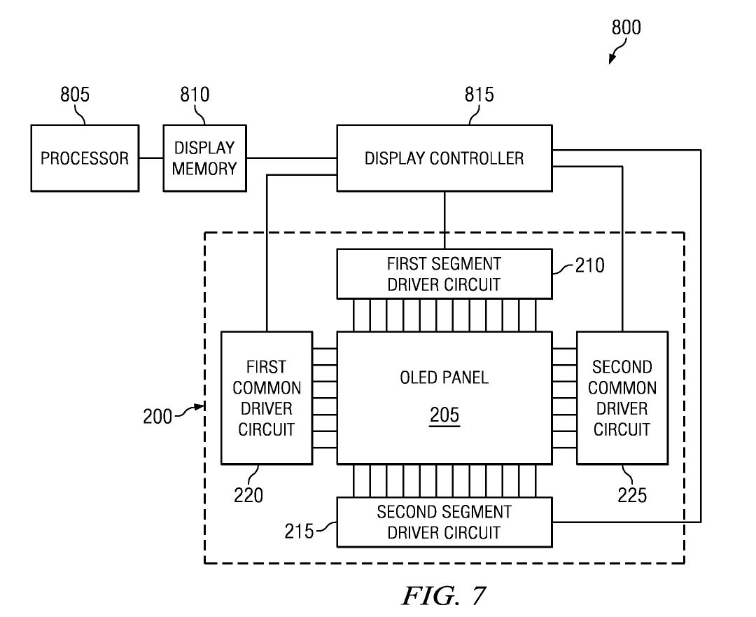

FIG. 7 illustrates an embodiment of an OLED display system 800 including the OLED display driving apparatus 200 of FIG. 2. The OLED display system 800 includes a processor 805, a display memory 810, a display controller 815, and the OLED display driving apparatus 200 including the first segment driver circuit 210, the second segment driver circuit 215, the first common driver circuit 220, and the second common driver circuit 225. The processor 805 is in communication with the display memory 810. The display memory 810 is in further communication with the display controller 815. The display controller 815 is in further communication with each of the first segment driver circuit 210, the second segment driver circuit 215, the first common driver circuit 220, and the second common driver circuit 225. The first segment driver circuit 210 is coupled to a first end of a plurality of segment lines 230-250 of the OLED display panel 205, and the second segment driver circuit 215 is coupled to second end of the plurality of segment lines 230-250 of the OLED display panel 205. The first common driver circuit 220 is coupled to a first end of a plurality of common lines 255-270 of the OLED display panel 205, and the second common driver circuit 225 is coupled to a second end of the plurality of common lines 255-270. Although the processor 805, the display memory 810, the display controller 815, the first segment driver circuit 210, the second segment driver circuit 215, the first common driver circuit 220, and the second common driver circuit 225 are illustrated as separate components, it should be understood that in some embodiments one or more of the components may be integrated into a single component.

During operation, the processor 805 stores one or more images to be displayed on the OLED display panel 205 within the display memory 810. In at least one embodiment, the processor 805 includes a central processing unit (CPU). The display controller 815 receives an image to be displayed on the OLED panel 205 and sends control signals to each of the first segment driver circuit 210, the second segment driver circuit 215, the first common driver circuit 220, and the second common driver circuit 225. The control signals instruct the first segment driver circuit 210 and the second segment driver circuit 215 to provide a driving signal to the segment lines 230-250 corresponding to the OLEDs D1-D20 that are to be illuminated in order to display the image. In addition, the control signals instruct the first common driver circuit 220 and the second common driver circuit 225 to scan the common lines 255-270 to generate the image on the OLED display panel 205.

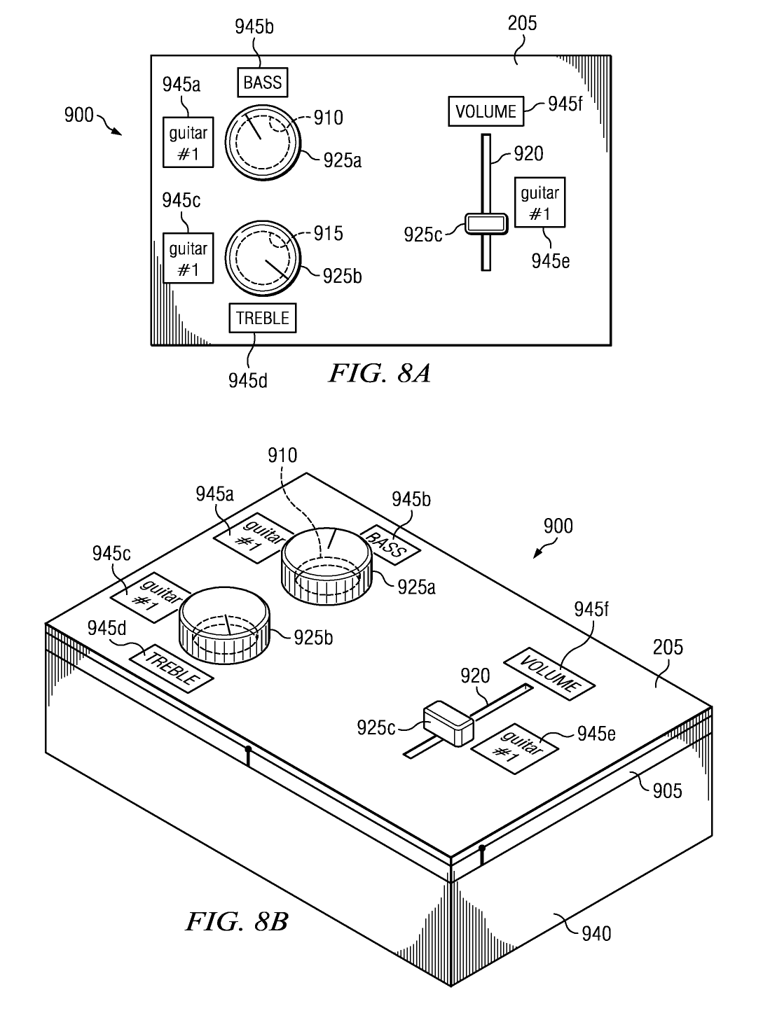

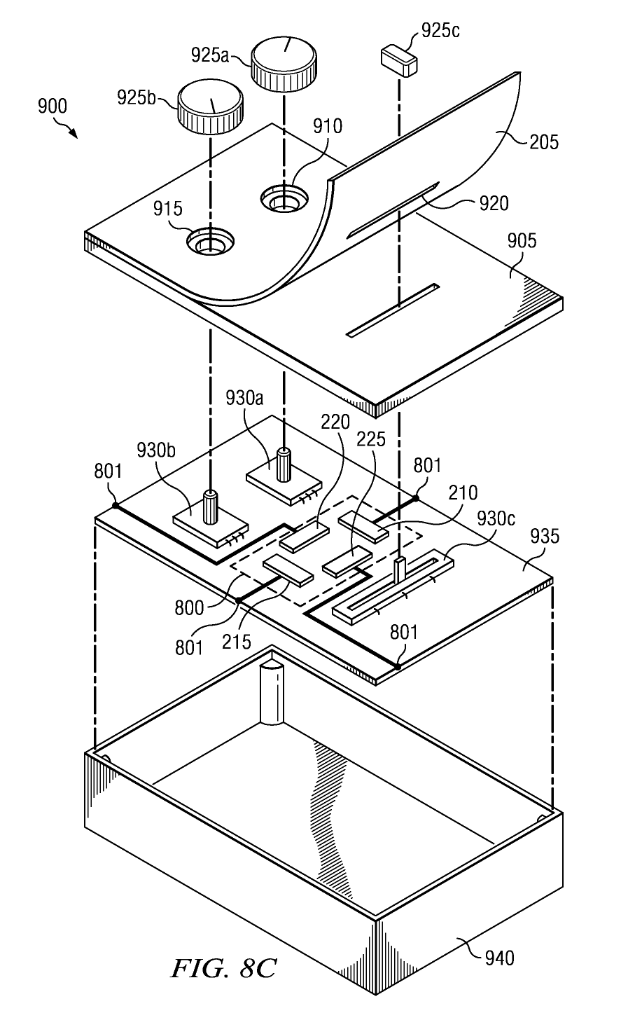

FIGS. 8A-8C illustrate an embodiment of an audio mixing console 900 including the OLED display driving apparatus 200 of FIG. 2. FIG. 8A illustrates a top view of the audio mixing console 900. FIG. 8B illustrates a perspective view of the audio mixing console 900. FIG. 8C illustrates an exploded view of the audio mixing console 900. The audio mixing console 900 includes an OLED display panel 205 overlaid on and attached to a console top 905. As illustrated particularly in FIG. 8C, the flexible and thin nature of the OLED display panel 205 allows the OLED display panel 205 to be attached to the console top 905 in a rolling motion. The OLED display panel 205 and console top 905 include a first substantially circular cut-out 910, a second substantially circular cut-out 915, and a slot cut-out 920 passing therethrough. The first substantially circular cut-out 910, the second substantially circular cut-out 915, and the slot cut-out 920 are configured to allow one or more user interface portions 925a, 925b, and 925c of one or more audio control devices 930a, 930b, 930c to be positioned through the OLED display panel 205. The one or more audio control devices 930a, 930b, 930c are mounted to a surface of a printed circuit board (PCB) 935 disposed within a console case 940. The OLED display panel 205 and console top 905 are further affixed to a top portion of the console case 940. In a particular embodiment, the audio control devices 930a and 930b include rotary potentiometers and the audio control device 930c includes a sliding potentiometer. In a particular embodiment, the one or more user interface portions 930a, 930b, and 930c include control knobs affixed to the audio control devices 930a, 930b, and 930c.

The audio mixing console 900 further includes the OLED display system 800 mounted to the surface of the PCB 935. The OLED display system 800 includes the first segment driver circuit 210 coupled to segment lines 230-250 at a top edge of the OLED display panel 205 (FIG. 2) with connectors 801 at the edge of panel 205, a second segment driver circuit 215 coupled to segment lines 230-250 at a bottom edge of the OLED display panel 205 with connectors 801, a first common driver circuit 220 coupled to common lines 255-270 at a left edge of the OLED display panel 205 with connectors 801, and a second common driver circuit 225 coupled to common lines 255-270 at a right edge of the OLED display panel 205 with connectors 801. The OLED display system 800 is configured to display one or more images on the OLED display panel 205. In at least one embodiment, the OLED display system 800 is configured to display an image including a plurality of labels 945a-945f corresponding to the audio control devices 930a-930c using the OLEDs D1-D20 of the OLED display panel 205.

In at least one embodiment, the audio mixing console 900 is configured to receive one or more audio signals, process the audio signals according to audio mixing processes controllable by the user using the one or more audio control devices 930a-930c, and output one or more processed audio signals. In various embodiments, the particular audio mixing processes corresponding to a particular audio control device 930a-930c are reconfigurable by the user. Accordingly, in at least one embodiment, the audio mixing console 900 is configured to allow the labels 945a-945f corresponding to the audio control devices 930a-930c to also be reconfigureable by displaying a new image on the OLED display 205. In the particular embodiment illustrated in FIGS. 8A-8B, the OLED display panel 205 is displaying an image in which the label 945a displaying “guitar #1” and the label 945b displaying “BASS” are associated with audio control device 930a, the label 945c displaying “guitar #1” and the label 945d displaying “TREBLE” are associated with audio control device 930b, and the label 945e displaying “guitar #1” and the label 945f displaying “VOLUME” are associated with audio control device 930c. However, if the user wishes to reconfigure the functions of audio control devices 930a-930c, a new image may be displayed on the OLED display panel 205 having labels corresponding to the new functions of the audio control devices 930a-930c. In still other embodiments, an audio mixing console may include a plurality of OLED display panels 205.

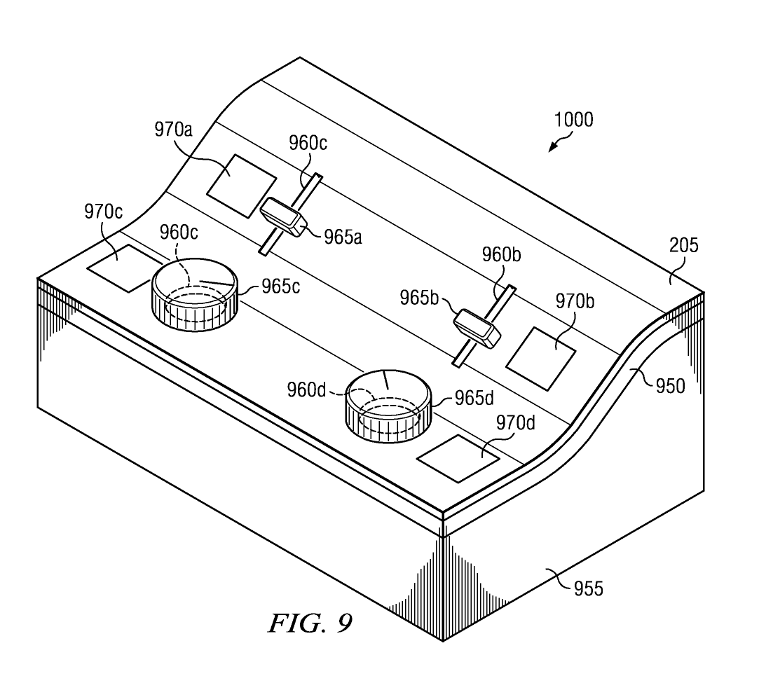

FIG. 9 illustrates a perspective view of an embodiment of an audio mixing console 1000 having an OLED display panel 205 affixed to a surface of a console top 950 having a curvilinear profile. Due to the flexible nature of certain embodiments of the OLED display panel 205, the OLED display panel 205 may be affixed to a curved surface and still maintain functionality. The OLED display panel 205 and console top 950 are further affixed to a console case 955. The OLED display panel 205 and console top 950 further include one or more cut-outs 960a-960d therethrough to allow the mounting of one or more audio control devices 965a-965d. The OLED display panel 205 is configured to display one or more labels 970a-970d associated with the one or more audio control devices 965a-965d.

Although the embodiments of FIGS. 8A-8C and 9 are illustrated using audio processing consoles in the form of audio mixing consoles, it should be understood that other embodiments may include any type of control panel and/or control console. In addition, although the embodiments described in FIGS. 1-9 are described as including an OLED display panel it should be understood that in other embodiments, any display panel matrix may be used. In addition, although the embodiments of FIGS. 1-9 are illustrated as using OLEDs, it should be understood that in other embodiments other types of display or illuminating elements, such as LCD display elements, may be used.

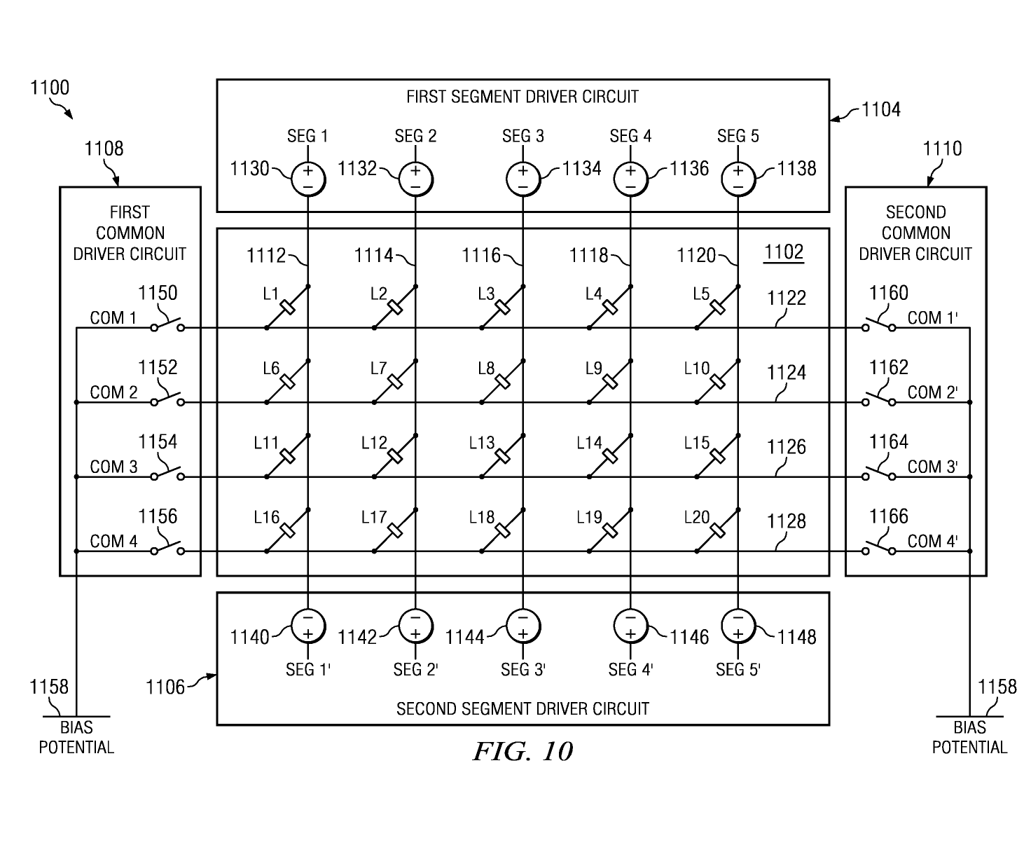

FIG. 10 illustrates an embodiment of an LCD display driving apparatus 1100. The LCD display driving apparatus 1100 includes an LCD display panel 1102, a first segment driver circuit 1104, a second segment driver circuit 1106, a first common driver circuit 1108, and a second common driver circuit 1110. The LCD display panel 1102 includes a first segment line 1112, a second segment line 1114, a third segment line 1116, a fourth segment line 1118, and a fifth segment line 1120, each arranged in a substantially vertical orientation and substantially parallel to each other. The LCD display panel 1102 further includes a first common line 1122, a second common line 1124, a third common line 1126, and a fourth common line 1128, each arranged in a substantially horizontal orientation and substantially parallel to each other. The segment lines 1112-1120 and common lines 1122-1128 are arranged in a grid configuration to form a display matrix. The LCD display panel 1102 further includes a number of LCD display elements L1-L20. Each of the LCD display elements L1-L20 is coupled between a particular segment line 1112-1120 and a particular common line 1122-1128. For example, LCD display element L1 is coupled between the first segment line 1112 and the first common line 1122. Although the described embodiments are illustrated as using twenty LCD display elements for the sake of clarity, it should be understood that in other embodiments, an LCD display panel including many more LCD display elements may be used.

The first segment driver circuit 1104 includes a first segment driver 1130 coupled to a first end of the first segment line 1112, a second segment driver 1132 coupled to a first end of the second segment line 1114, a third segment driver 1134 coupled to a first end of the third segment line 1116, a fourth segment driver 1136 coupled to a first end of the fourth segment line 1118, and a fifth segment driver 1138 coupled to a first end of the fifth segment line 1120. The second segment driver circuit 1106 includes a sixth segment driver 1140 coupled to a second end of the first segment line 1112, a seventh segment driver 1142 coupled to a second end of the second segment line 1114, an eight segment driver 1144 coupled to a second end of the third segment line 1116, a ninth segment driver 1146 coupled to a second end of the fourth segment line 1118, and a tenth segment driver 1148 coupled to a second end of the fifth segment line 1120. In at least one embodiment, each of the first segment driver 1130, second segment driver 1132, third segment driver 1134, fourth segment driver 1136, fifth segment driver 1138, sixth segment driver 1140, seventh segment driver 1142, eighth segment driver 1144, ninth segment driver 1146, and tenth segment driver 1148 include a voltage source. Each of the first segment driver 1130, second segment driver 1132, third segment driver 1134, fourth segment driver 1136, fifth segment driver 1138, sixth segment driver 1140, seventh segment driver 1142, eighth segment driver 1144, ninth segment driver 1146, and tenth segment driver 1148 are configured to provide a driving signal to the segment line 1122-1118 to which it is coupled in response to receiving a respective control signal seg1, seg2, seg3, seg4, seg5, seg1′, seg2′, seg3′ seg4′, and seg5′.

The first common driver circuit 1108 includes a first switch 1150 coupled to a first end of the first common line 1122, a second switch 1152 coupled to a first end of the second common line 1124, a third switch 1154 coupled to a first end of the third common line 1126, and a fourth switch 1156 coupled to a first end of the fourth common line 1128. Each of the first switch 1150, second switch 1152, third switch 1154, and fourth switch 1156 are configured to couple the common line 1122-1128 to which it is coupled to a bias potential 1158 in response to receiving a respective control signal com1, com2, com3, and com4. In at least one embodiment, the bias potential 1158 is a ground connection. The second common driver circuit 1110 includes a fifth switch 1160 coupled to a second end of the first common line 1122, a sixth switch 1162 coupled to a second end of the second common line 1124, a seventh switch 1164 coupled to a second end of the third common line 1126, and an eighth switch 1166 coupled to a second end of the fourth common line 1128. Each of the fifth switch 1160, sixth switch 1162, seventh switch 1164, and eighth switch 1166 are configured to couple the common line 1122-1128 to which it is coupled to the bias potential 1158 in response to receiving a respective control signal com1′, com2′, com3′, and com4′.

In order to illuminate a particular LCD display element L1-L20, the segment line 1112-1120 to which the particular LCD display element L1-L20 is coupled is provided with one or more driving signals, such as a driving voltage, and the common line 1122-1128 to which the particular LCD display element L1-L20 is coupled is connected to the bias potential 1158, thereby allowing voltage to flow through the particular LCD display element L1-L20 resulting in illumination of the LCD display element L1-L20. In a particular embodiment in which it is desired to illuminate LCD display element L1, a first control signal seg1 is provided to the first segment driver circuit 1104 indicating that first segment driver circuit 1104 should activate first segment driver 1130 to provide a first driving signal to a first end of first segment line 1112. Additionally, a second control signal seg1′ is provided to the second segment driver circuit 1106 indicating that the second segment driver circuit 1106 should activate the sixth segment driver 1140 to provide a second driving signal to a second end of the first segment line 1112. A third control signal (com1) is provided to both the first common driver circuit 1108 and a fourth control signal (com1′) is provided to the second common driver circuit 1110. The third control signal (com 1) instructs the first common driver circuit 1108 to close the first switch 1150 to couple a first end of the first common line 1122 to the bias potential 1158, and the fourth control signal (com1′) instructs the second common driver circuit 1110 to close the fifth switch 1160 to couple a second end of the first common line 1122 to the bias potential 1158. Various embodiments the LCD display panel 1102 operate in similar manner to the embodiments of the OLED display panel 205 described with respect to FIGS. 1-9.

In other embodiments, the first common driver circuit 1108 and the second common driver circuit 1110 may be configured to provide common driving signals to each of the common lines 1122-1128 instead of directly coupling the common lines 1122-1128 to the bias potential 1158. In a particular embodiment, the LCD display panel 1102 may be an active-matrix display in which each of the LCD display elements L1-L20 include a thin film transistor (TFT) (Not specifically shown for figure clarity purposes) having a gate that is coupled to a particular common line 1112-1128. In response to the gate of a TFT associated with a particular LCD display element L1-L20 receiving the common drive signal from one or more of the first common driver circuit 1108 and the second common driver circuit 1110, the TFT is switched on thereby coupling the particular LCD display element L1-L20 to the bias potential 1158. Wherein the bias potential 1158 is a ground connection, a common ground plane, a positive bias, or a negative bias depending on the type (N or P type) of TFT used in conjunction with the LCD display elements. As a result, the driving signal from one or more of the first segment driver circuit 1104 and second segment driver circuit 1106 flows through the particular LCD display element L1-L20 and into the bias potential 1158, resulting in illumination of the particular LCD display element L1-L20. In at least one embodiment, the common driving signals are applied to the first and second ends of the particular common line 1122-1128 at substantially the same time. In other embodiments, the common driving signals are applied to the first and second ends of the particular common line 1122-1128 at different times.

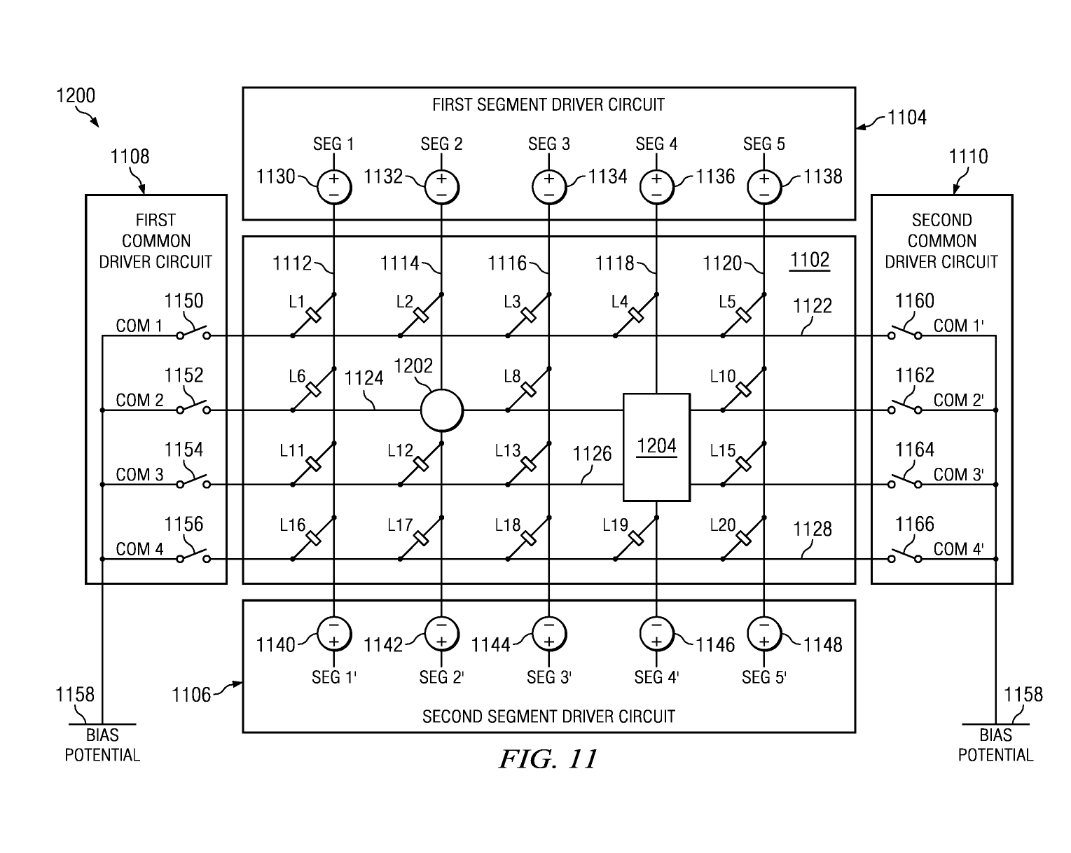

FIG. 11 illustrates an embodiment of an LCD display driving apparatus 1200 having a substantially circular cut-out 1202 and substantially rectangular cut-out 1204 through the LCD display panel 1102. In particular embodiments, the circular cut-out 1202 and rectangular cut-out 1204 may be used to pass one or more control devices, such as switches, sliders, or knobs, through the LCD display panel 1102. In the embodiment illustrated in FIG. 11, the circular cut-out 1202 results in the removal of LCD display element L7, as well as breaks or discontinuities in the second segment line 1114 and the second common line 1124. The rectangular cut-out 1204 results in the removal of LCD display element L9 and LCD display element L14, as well as breaks in the fourth segment line 1118, the second common line 1124, and the third common line 1126. Use of the second segment driver circuit 1106 to provide a second driving signal to the second segment line 1114 and the fourth segment line 1118, and the second common driver circuit 1110 to couple common lines 1124 and 1126 to the bias potential 1158, enables LCD display elements L1-L6, L10-L13, and L15-L20 to remain operable despite the presence of the circular cut-out 1202 and the rectangular cut-out 1204. However, in the embodiment of FIG. 11, LCD display element L8 remains inoperative since it has no connection to the bias potential 1158. Without the use of the second segment driver circuit 1106 and second common driver circuit 1110, LCD display elements L10, L12, L15, L17, and L19 would also remain inoperable. Although the embodiment of FIG. 6 is illustrated with respect to a circular cut-out 1202 and rectangular cut-out 1204, it should be understood that in other embodiments the LCD display panel 1102 may have one or more cut-outs of any shape and/or size.

It will be appreciated by those skilled in the art having the benefit of this disclosure that embodiments of this organic LED control surface display circuitry provides an OLED display driving apparatus including a first segment driver circuit, second segment driver circuit, first common driver circuit and second common driver circuit which allow one or more cut-outs to be disposed within an OLED display panel while maintaining functionality of a substantial number of OLEDs of the OLED display panel. Additionally, some embodiments provide an LCD display driving apparatus that includes a first segment driver circuit, second segment driver circuit, first common driver circuit and second common driver circuit which allow one or more cut-outs to be disposed within an LCD display panel while maintaining functionality of a substantial number of LCD display elements of the LCD display panel. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A display apparatus comprising:
a display panel including:
at least one segment line;
at least one common line; and
at least one display element coupled between the at least one segment line and the at least one common line;
a first segment driver circuit including at least one first segment driver, the at least one first segment driver coupled to a first end of the at least one segment line and configured to receive a first control signal and provide a first driving signal to the first end of the at least one segment line in response to receiving the first control signal;
a second segment driver circuit including at least one second segment driver, the at least one second segment driver coupled to a second end of the at least one segment line and configured to receive a second control signal and provide a second driving signal to the second end of the at least one segment line in response to receiving the second control signal;
a first common driver circuit including at least one first common driver, the at least one first common driver coupled to a first end of the at least one common line and configured to receive a third control signal and couple the at least one display element to a bias potential in response to receiving the third control signal; and
a second common driver circuit including at least one second common driver, the at least one second common driver coupled to a second end of the at least one common line and configured to receive the third control signal and couple the at least one display element to the bias potential in response to receiving the third control signal.

2. The display apparatus of claim 1, wherein the bias potential is one of a ground connection, a positive bias connection and a negative bias connection.

3. The display apparatus of claim 1, wherein the at least one display element comprises an organic light-emitting diode (OLED).

4. The display apparatus of claim 1, wherein the at least one display element comprises an LCD display element.

5. The display apparatus of claim 1, wherein the first common driver circuit is further configured to couple the at least one display element to the bias potential by providing a common drive signal to a gate of a transistor associated with the at least one display element, the transistor coupling the at least one display element to the bias potential in response to receiving the common drive signal.

6. The display apparatus of claim 1, wherein the first segment driver circuit includes at least one first current source coupled to the first end of the at least one segment line, the at least one first current source configured to provide the first driving signal to the first end of the at least one segment line in response to receiving the first control signal; and
wherein the second segment driver circuit includes at least one second current source coupled to the second end of the at least one segment line, the at least one second current source configured to provide the second driving signal to the second end of the at least one segment line in response to receiving the second control signal.

7. The display apparatus of claim 1, wherein the first common driver circuit includes at least one first switch, the at least one first switch coupled to the first end of the at least one common line and configured to couple the at least one common line to the bias potential in response to receiving the third control signal; and
wherein the second common driver circuit includes at least one second switch, the at least one second switch coupled to the second end of the at least one common line and configured to couple the at least one common line to the bias potential in response to receiving the third control signal.

8. The display of claim 1, wherein the display panel includes one or more cut-outs therethrough.

9. The display of claim 8, wherein the one or more cut-outs are configured to pass at least one control device therethrough.

10. A control console comprising:
a display panel including:
at least one segment line;
at least one common line; and
at least one display element coupled between the at least one segment line and the at least one common line;
wherein the display panel includes one or more cut-outs therethrough;
a first segment driver circuit including at least one first segment driver, the at least one first segment driver coupled to a first end of the at least one segment line and configured to receive a first control signal and provide a first driving signal to the first end of the at least one segment line in response to receiving the first control signal;
a second segment driver circuit including at least one second segment driver, the at least one second segment driver coupled to a second end of the at least one segment line and configured to receive a second control signal and provide a second driving signal to the second end of the at least one segment line in response to receiving the second control signal;
a first common driver circuit including at least one first common driver, the at least one first common driver coupled to a first end of the at least one common line and configured to receive a third control signal and couple the at least one display element to a bias potential in response to receiving the third control signal;
a second common driver circuit including at least one second common driver, the at least one second common driver coupled to a second end of the at least one common line and configured to receive the third control signal and couple the at least one display element to the bias potential in response to receiving the third control signal; and
at least one control device passing through the at least one cut-out.

11. The control console of claim 10, wherein the at least one display element comprises an organic light-emitting diode (OLED).

12. The control console of claim 10, wherein the at least one display element comprises an LCD display element.

13. The control console of claim 10, wherein the first segment driver circuit includes at least one first current source coupled to the first end of the at least one segment line, the at least one first current source configured to provide the first driving signal to the first end of the at least one segment line in response to receiving the first control signal; and
wherein the second segment driver circuit includes at least one second current source coupled to the second end of the at least one segment line, the at least one second current source configured to provide the second driving signal to the second end of the at least one segment line in response to receiving the second control signal.

14. The control console of claim 10, wherein the first common driver circuit includes at least one first switch, the at least one first switch coupled to the first end of the at least one common line and configured to couple the at least one common line to the bias potential in response to receiving the third control signal; and
wherein the second common driver circuit includes at least one second switch, the at least one second switch coupled to the second end of the at least one common line and configured to couple the at least one common line to the bias potential in response to receiving the third control signal.

15. A display apparatus comprising:
a display panel including:
at least one segment line;
at least one common line; and
at least one display element coupled between the at least one segment line and the at least one common line;
a first segment driver circuit including at least one first segment driver, the at least one first segment driver coupled to a first end of the at least one segment line and configured to receive a first control signal and provide a first driving signal to the first end of the at least one segment line in response to receiving the first control signal;
a second segment driver circuit including at least one second segment driver, the at least one second segment driver coupled to a second end of the at least one segment line and configured to receive a second control signal and provide a second driving signal to the second end of the at least one segment line in response to receiving the second control signal; and
a first common driver circuit including at least one first common driver, the at least one first common driver coupled to a first end of the at least one common line and configured to receive a third control signal and couple the at least one display element to a bias potential in response to receiving the third control signal.

16. The display apparatus of claim 15 further comprising:
a second common driver circuit including at least one second common driver, the at least one second common driver coupled to a second end of the at least one common line and configured to receive the third control signal and couple the at least one display element to the bias potential in response to receiving the third control signal.

17. A display apparatus comprising:
a display panel including:
at least one segment line;
at least one common line; and
at least one display element coupled between the at least one segment line and the at least one common line;
a first segment driver circuit including at least one first segment driver, the at least one first segment driver coupled to a first end of the at least one segment line and configured to receive a first control signal and provide a first driving signal to the first end of the at least one segment line in response to receiving the first control signal;
a first common driver circuit including at least one first common driver, the at least one first common driver coupled to a first end of the at least one common line and configured to receive a second control signal and couple the at least one display element to a bias potential in response to receiving the second control signal; and
a second common driver circuit including at least one second common driver, the at least one second common driver coupled to a second end of the at least one common line and configured to receive the second control signal and couple the at least one display element to the bias potential in response to receiving the second control signal.

18. The display apparatus of claim 17 further comprising:
a second segment driver circuit including at least one second segment driver coupled to a second end of the at least one segment line and configured to receive a third control signal and provide a second driving signal to the second end of the at least one segment line in response to receiving the third control signal.

19. A display comprising:
a plurality of illuminating elements arranged in an array of rows and columns;
a plurality of row lines for delivering a row signal to connected ones of the illuminating elements in an associated row;
a plurality of column lines for delivering a column signal to connected ones of the illuminating elements in an associated column;
at least one opening defined in the array;
the at least one opening defining one or more discontinuities in the associated row and column lines; and
signal generators for generating column and row signals to either end of the row and signal lines such that the plurality of illuminating elements can be illuminated on either side of the at least one opening.

20. The display of claim 19, wherein the signal generators are configured to provide the column and row signals to each end of the row and column lines at a different time.

21. The display of claim 19, wherein the signal generators are configured to provide the column and row signals to each end of the row and column lines at substantially the same time.

22. The display of claim 19, wherein the plurality of illuminating elements comprise a plurality of organic light-emitting diodes (OLEDs).

23. The display of claim 19, wherein the plurality of illuminating elements comprise a plurality of LCD display elements.

24. The display of claim 19, wherein the signal generators include:
a first segment driver configured to provide the column signals to a first end of each of the column lines; and
a second segment driver configured to provide the column signals to a second end of each of the column lines.

25. The display of claim 19, wherein the signal generators include:
a first common driver configured to provide the row signals to a first end of each of the row lines; and
a second common driver configured to provide the row signals to a second end of each of the row lines.
